(19) United States
(12) Patent Application Publication
(10) Pub. No.: US 2009/0310453 A1
(43) Pub. Date: Dec. 17, 2009

(54) OPTICAL DRIVE AND READ POWER ESTIMATION METHOD

(75) Inventors: Johannes Leopoldus Bakx, Eindhoven (NL); Maarten Kuijper, Eindhoven (NL); Franco Bart, Brussel (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/374,401

(22) PCT Filed: Jul. 20, 2007
(86) PCT No.: PCT/IB07/52896

§ 371 Date: Jan. 20, 2009

(30) Foreign Application Priority Data
Jul. 20, 2006 (EP) 06117537.8

(51) Int. Cl. G11B 7/12

(52) U.S. Cl. 369/47.53; G9B/7

(57) ABSTRACT

A method of determining a maximum allowable read power for a drive-record carrier combination is described. The method finds a forward-sense setpoint value to control a light power control loop, by reading data from the record carrier at which degradation of the data occurs. This technique is useful for all optical storage devices such as CD, DVD and Blu-ray players and recorders.

### FIELD OF THE INVENTION

The invention relates to optical drives, and more specifically to read power estimation methods for an optical drive-optical disc combination.

### BACKGROUND OF THE INVENTION

JP2003006941 discloses a method of evaluating the reproduction durability of an optical recording medium. The method comprises using three different playback power values and performing repetitive playback. The reproduction characteristics for each playback power are measured. A relation between the common logarithm of the count of playback and the playback power is calculated with a least square method. The playback power obtained using this method is generally not accurate.

It would be advantageous to have a method that accurately determines the maximum allowable read power for a disc/drive combination. It would also be advantageous to have a device that accurately determines the maximum allowable read power for a disc/drive combination.

### SUMMARY OF THE INVENTION

A method of determining a maximum allowable read power for a drive-record carrier combination is described. The method comprises finding a forward-sense setpoint value to control a light power control loop, by reading data from the record carrier at which degradation of the data occurs.

A device for determining a maximum allowable read power for a drive-record carrier combination is described. The device comprises a forward-sense setpoint-value-finding unit arranged to find a forward-sense setpoint value to control a light power control loop, by reading data from the record carrier at which degradation of the data occurs.

Further, the method of determining the maximum allowable read power for a drive-record carrier combination could be implemented with a computer program.

### BRIEF DESCRIPTION OF THE DRAWINGS

These and other aspects, features and advantages will be further explained by the following description, by way of example only, with reference to the accompanying drawings, in which same reference numerals indicate same or similar parts, and in which:

FIG. 1 and FIG. 1a schematically illustrate an example of a drive-record carrier combination and a light power control loop;

FIG. 2 is a Transmission Electron Microscope (TEM) picture (of a record carrier) showing an example of destroyed amorphous marks with holes inside due to readout with too high a power;

FIG. 3 shows an example of an Arrhenius plot (read stability) depicting the correlation between read power and obtainable read cycles;

FIG. 4 shows an example of a graph depicting the read cycles as a function of repeated read power and average Jitter;

FIG. 5 shows an example of a graph depicting the read cycles as a function of repeated read power and average symbol error rate; and

FIG. 6 shows an example of Jitter increase between one-time data read out and N^{th} time data read out.

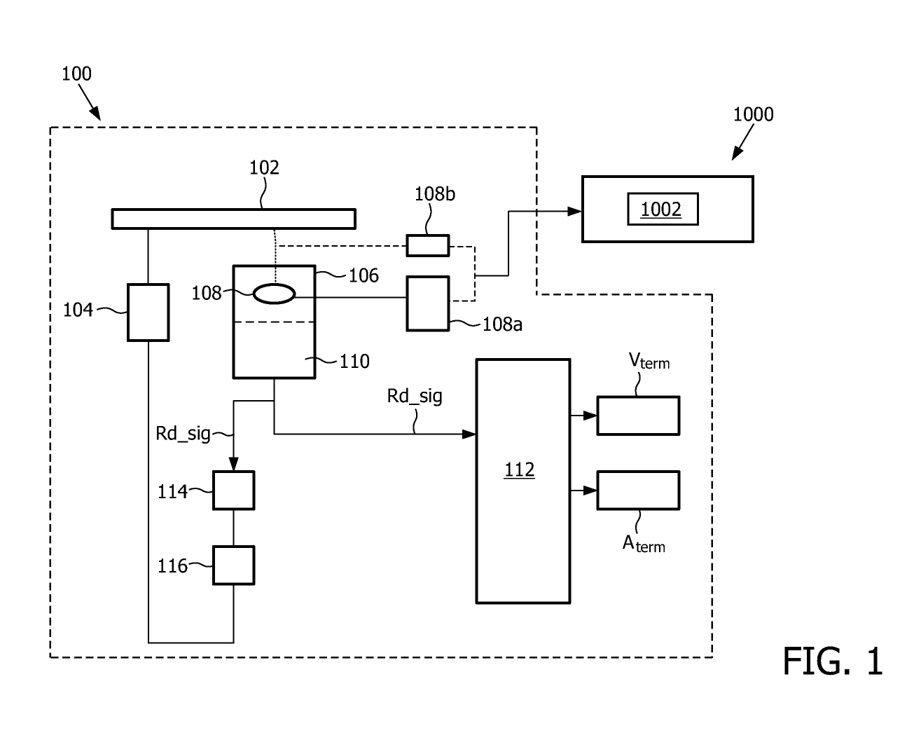

Referring to FIG. 1, one example of a drive 100 (e.g. Blu-ray drive) and a record carrier 102 (e.g. Blu-ray disc) is shown. A spindle motor 104 rotationally drives the Blu-ray disc 102. An optical pick-up unit 106 irradiates the Blu-ray disc 102 with laser light emitted by the blue laser light source 108, e.g. a blue laser diode.

Now, referring to FIG. 1 and FIG. 1a, in order to make the laser light emission by the blue laser light source 108 stable, a method referred to as forward-sense light power control loop is generally used. The drive 100 uses the forward-sense setpoint values—FS0, FS1, and FSmax available in the drive firmware. A portion of the laser beam emitted from the blue laser light source 108 is measured by the photo-detector 108b, generally referred to as forward-sense detector. The output of the photo-detector 108b (FS2) is compared with a forward-sense setpoint value (FS0) applied by the drive 100. The difference between the output (FS2) and the input (FS0) is calculated. This difference is passed to the laser light source power controller 108a, which produces a laser current that will make the forward-sense setpoint equal to the difference between the output and the input, i.e. FS2-FS0, thus controlling the power emitted by the laser light source 108. For example, a setpoint Digital-Analog-Converter (DAC) determines the desired level of optical power output from the blue laser light source 108. A digital value written in the setpoint DAC produces an analog output voltage, which is used as the setpoint for the laser (light) power control loop. The laser source power controller 108a takes a voltage signal as an input, and uses it to provide a proportional current output (e.g. 100-500 mA) to the laser light source 108. A current-to-voltage converter takes the output current from the photo-detector 108b and provides a voltage signal. This voltage signal is subtracted from the setpoint value. The resulting error signal is then used to provide stable control of the laser light source 108. The laser light source controller 108a controls the amount of radiation emitted by the laser light source 108 (e.g. a read level and a write level). It is noted that there are many ways in which the forward-sense light power control loop can be implemented, and FIG. 1a shows one example of a possible implementation.

Now, referring to FIG. 1, the optical pick-up unit 106 receives light reflected on the Blu-ray disc 102 to generate a signal in accordance with the intensity of the received light. Furthermore, a photo-detector 110 (e.g. photo-diode) disposed within the optical pick-up unit 106 receives the beam of light reflected on the Blu-ray disc 102. The photo-detector then converts the light into electric signals (i.e. current), which in turn are output as read signals Rd_sig. The read signals Rd_sig are applied to a digital signal-processing unit of the micro-controller 112.

Now, referring to FIG. 1, the digital signal-processing unit processes the received read signals and the processed signal is accordingly sent to a video external output terminal Vₜₑᵣₘ and/or to an audio external output terminal Aₜₑᵣₘ or to a data external output terminal (e.g. a personal computer). The optical pick-up unit 106 is generally provided with a tracking actuator and a focusing actuator. The tracking actuator changes the direction of an objective lens to displace a read point of the laser beam spot in the radial direction of the Blu-ray disc 102. The focusing actuator controls the focus position of the aforementioned laser beam spot. In the above configuration, the optical pick-up unit 106 reads information recorded on the Blu-ray disc 102 and outputs the read signal Rd_sig. A unit 114 extracts a tracking error signal and a focusing error signal from the read signal Rd_sig. The tracking error signal and the focusing error signal are supplied to a driver 116 which uses the tracking error signal and the focusing error signal to control the tracking actuator, the focusing actuator, the slide motor and the spindle motor 104.

The construction shown in FIG. 1 only illustrates parts related to the general operation of a Blu-ray drive 100. The description and detailed explanation of servo circuits for controlling the optical pick-up unit, the spindle motor, the slide motor, the digital signal-processing unit and the like are omitted, because they are constructed in a similar manner as in conventional systems.

Blu-ray disc media are generally vulnerable to excessive read powers, i.e. data can generally be destroyed by readout if too high a laser power is used. In addition, a high drive temperature will accelerate this read instability. On the other hand, it is often important to use the highest possible read power in order to have a good signal-to-noise ratio. Some Blu-ray media are less tolerant to high read powers than others.

Reading the recorded information from the Blu-ray disc 102 (phase change media) with too high a power can generally destroy the recorded information. The logical nature of re-writable phase change media is that at the extreme limit with read power P_{read}=erase power, the data is completely erased within one cycle. At lower read powers the obtainable cycles rapidly increases. The destruction of the user data occurs by the formation of nuclei or defects in the written amorphous marks with a probability η. The obtainable read cycles are related to the probability according to:

probability η=exp(−E/kT)

Temperature T∝P_{read}

Readcycles Read_{cycles}∝1/η (Arrhenius plot to extrapolate 10⁶ read cycles)

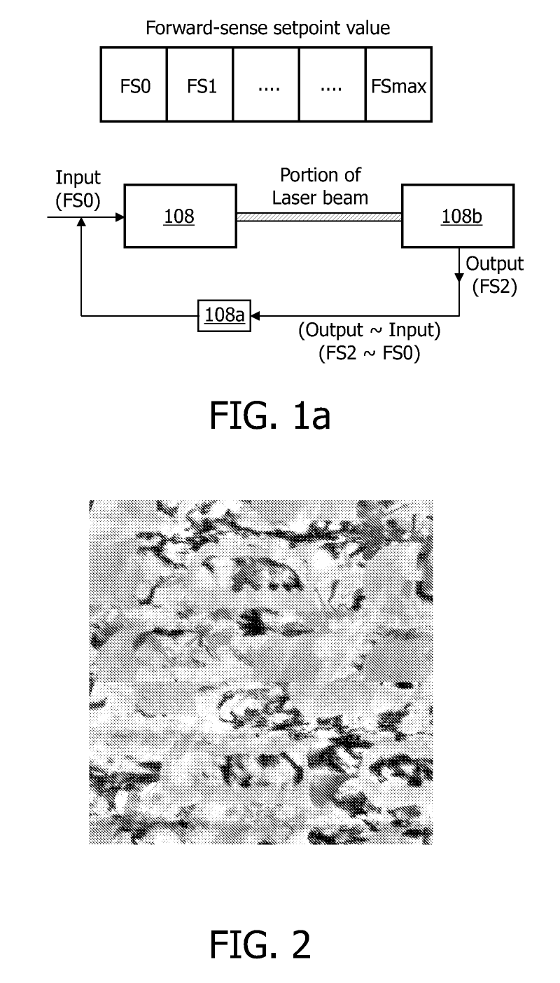

FIG. 2 shows a Transmission Electron Microscope (TEM) picture (of a Blu-ray disc) showing an example of destroyed amorphous marks with holes inside due to readout with too high a power. It is to be noted that in case of recordable media, significant heat accumulated alters the physical or chemical material structure of the recording layer. The destruction of the user data occurs by forming more and more partly altered properties of the original untouched spaces by coloring, bleaching, changing alloy properties or phase transitions. The recorded marks in general do not degrade further.

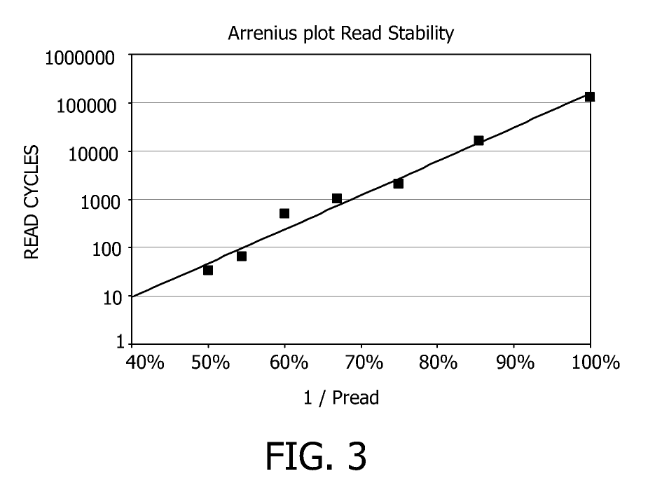

FIG. 3 shows an example of an Arrhenius plot (read stability) depicting the correlation between read powers and obtainable read cycles. The vertical axis shows the number of read cycles and the horizontal axis shows (1/P_{read}). It can be observed from FIG. 3 that the impact of the read power on the number of read cycles is high. At the same time, the limited light power returning from the Blu-ray disc 102 (Cf. FIG. 1), which is sent to the photo-detector 110 (Cf. FIG. 1), makes read out of the data very critical to the signal-to-noise ratio of the RF-signal. This has already been observed for BD-RE-DL at 2×. In general, a higher read power is wanted, but is not allowed by the disc standard.

Therefore, it would be advantageous to have a method, which enables the maximum allowable read power to be accurately determined for a combination of a drive 100 (Cf. FIG. 1) and a record carrier 102 (Cf. FIG. 1).

### DETAILED DESCRIPTION OF THE EMBODIMENTS

A method of determining the maximum allowable read power for the combination of drive 100 (Cf. FIG. 1) and record carrier 102 (Cf. FIG. 1) is disclosed. A forward-sense setpoint value (Cf. FIG. 1a) is found to control a light power control loop, by reading data from the record carrier 102 (Cf. FIG. 1) at which degradation of the data occurs.

The method finds the maximum current produced by the photo-detector 108b that is used in the laser (light) power control loop. This makes the method independent of the accuracy of the laser power adjustment procedure. Furthermore, the method does not rely on a logarithmic dependency of Jitter on read power and does not require a least-square fit as disclosed in JP2003006941. The method determines at which current level the read data characteristic has changed by a certain amount. This is much simpler and does not depend on the record carrier (i.e. disc) physics.

The solution disclosed in JP2003006941 determines the maximum read power of the main beam (of laser light). The precise value of the power in the main beam is not known to the drive 100 (Cf. FIG. 1). This is due to the finite accuracy of the adjustment procedure during manufacturing and because the power in the main beam cannot be measured directly. Only the total power from the objective lens is generally measured. This implies that the actual read power in the drive 100 (Cf. FIG. 1) might differ substantially from the target value during adjustment.

The drive firmware has access only to forward-sense setpoint values (Cf. FIG. 1a), and via a calibration in the factory the relation between setpoint and the total power (out of the objective lens) is known with a limited accuracy, e.g. 20%. The essence of the method is to establish at which value of the forward-sense setpoint (Cf. FIG. 1a), degradation of the data (written on the Blu-ray disc 102) occurs. Because of the tolerances, the drive 100 (Cf. FIG. 1) will not precisely know to which (main) beam power (in mW) this corresponds. The drive 100 (Cf. FIG. 1) only needs to know what forward-sense setpoint value it should apply to guarantee safe readout.

In an embodiment, the forward-sense setpoint value (Cf. FIG. 1a) to control the light power control loop is found during the idle time of the drive 100 (Cf. FIG. 1), i.e. the time periods where no activities are required by a host. Hence, the method is less time-critical.

In a still further embodiment, finding the forward-sense setpoint value during the idle time of the drive includes reading the data from the record carrier 102 (Cf. FIG. 1) and measuring a parameter of the read data. The parameter can be Jitter, symbol error rate, RF-asymmetry, RF-modulation, time interval analyzer statistics and carrier-to-noise ratio. The forward-sense setpoint value is found based on the measured parameter. This requires the following steps, and a schematic illustration is shown in Table 1:

Step 1: Recording dummy data on a test area of the Blu-ray disc 102 (Cf. FIG. 1).
Step 2: Initializing the forward-sense setpoint value to a minimum setpoint value allowable by the drive 100 (Cf. FIG. 1a).
Step 3: Reading the data written on the Blu-ray disc 102 (Cf. FIG. 1) one-time and measuring a parameter of the read data.
Step 4: Reading the data written on the Blu-ray disc 102 (Cf. FIG. 1) N times and measuring the parameter of the read data while reading the data the N^{th} time.
Step 5: Increasing the forward-sense setpoint value and repeating steps 2 and 3 at each forward-sense setpoint value, until the forward-sense setpoint value reaches a maximum value allowable by the drive 100 (Cf. FIG. 1a).
Step 6: Finding the forward-sense setpoint value based on the measured parameter.

It is to be noted that data is recorded on the test area of the Blu-ray disc 102 by recording several tracks for example in the drive calibration zone of the Blu-ray disc 102. The data recorded on the test area (e.g. power calibration area) is read and the estimation of the maximum allowable read power is carried out. It is not allowed to perform the repeated read operation on real (i.e. user) data as data might be destroyed by the high read out power.

TABLE 1

| | Measured | Measured | |
|---|---|---|---|
| Forward-sense | Parameter | Parameter | |
| setpoint | One-time data | N^{th} time data | Difference |
| Values (FS) | readout (A) | readout (B) | (A − B) |
| Min | | | |
| . . . | | | |
| The setpoint value at | | | |
| which (A~B) has | | | |
| changed by a pre- | | | |
| determined amount | | | |
| . . . | | | |
| Max | | | |

In a still further embodiment, the forward-sense setpoint value at which the measured parameter has changed, between one-time data readout and N^{th} time data readout, by a pre-determined amount is determined. In other words, during readout certain characteristics of the data are measured. It is determined at which power value the used characteristic has changed by a certain amount, e.g. an increase in Jitter by 2%. The maximum allowed read power is derived using the found power value, e.g. by using interpolation or extrapolation.

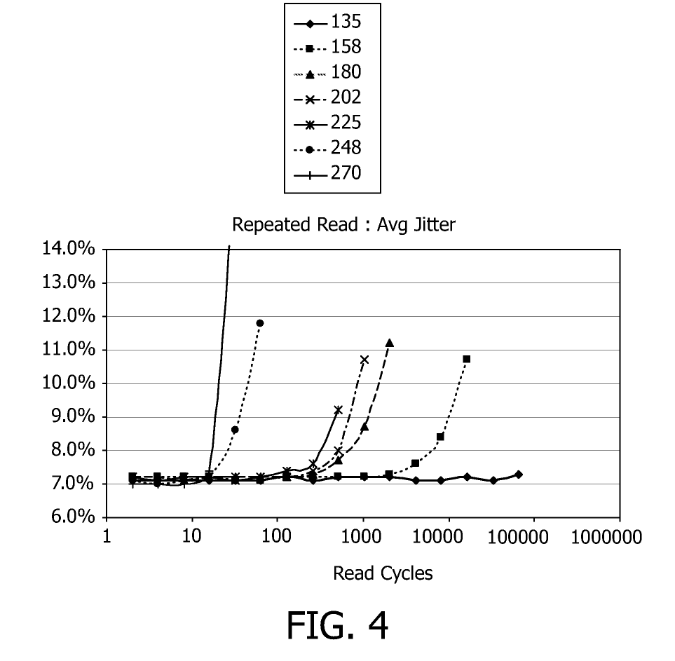

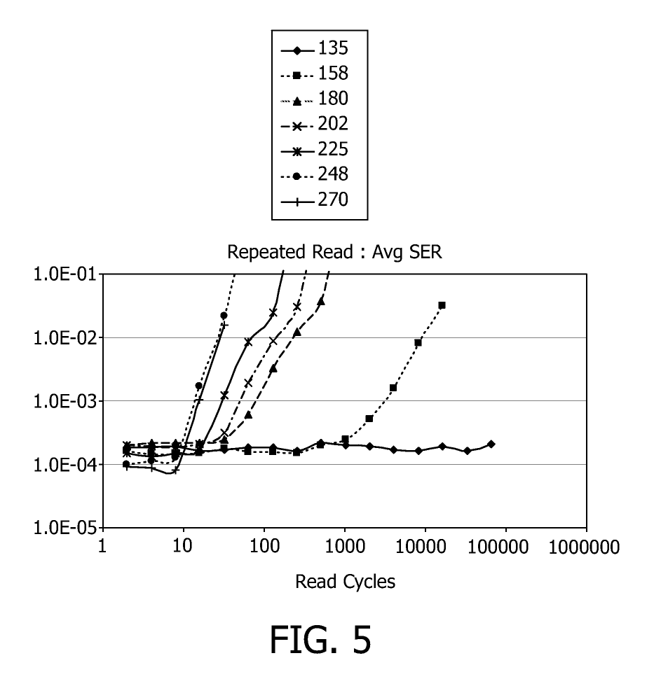

FIG. 4 shows an example of a graph depicting the read cycles as a function of repeated read power and average Jitter. FIG. 5 shows an example of a graph depicting the read cycles as a function of repeated read power and average symbol error rate.

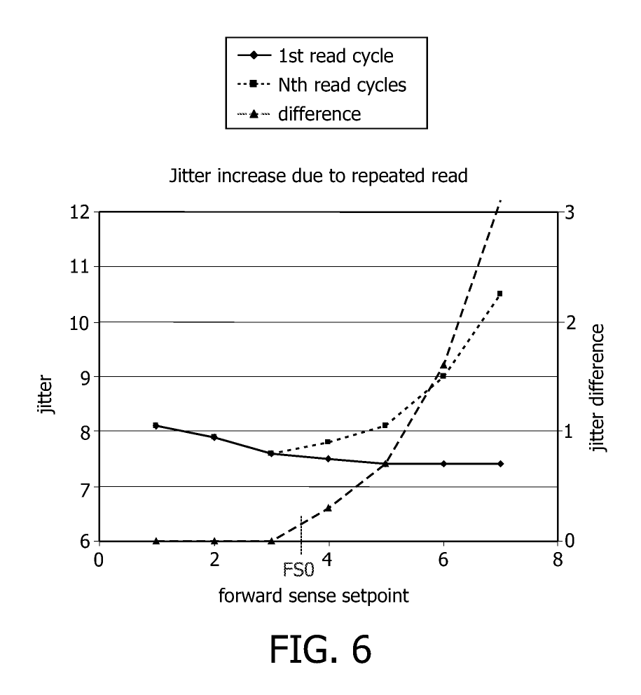

FIG. 6 shows an example of Jitter measurement carried out on an exemplary Blu-ray disc 102 (Cf. FIG. 1). In FIG. 6, the vertical axis shows the increase of Jitter and the horizontal axis shows the forward-sense setpoint values. It can be observed that the Jitter increases between one-time data readout and N^{th} time data readout. The one-time read cycle Jitter decreases with increased forward-sense setpoint. The N^{th} time readout cycle shows the increase of the Jitter after N-read cycles. FIG. 6 also shows the Jitter difference between 1^{st} read cycle and N^{th} read cycle. Referring to FIG. 6, the forward-sense setpoint value FS0 follows from interpolation between the point where the Jitter difference is still zero, and the first point where the Jitter difference differs from zero.

In a still further embodiment, a safety margin is taken into account, e.g. by using a forward-sense setpoint value, which is 10% smaller than the value found from interpolation. This safety margin is used to compensate for the difference between N and the real number of read cycles M>N that must be guaranteed to have a good read performance. The number N can be determined by experiment. N should generally be high enough to cause degradation of data at practical values of read power, but also low enough to avoid long calibration times.

In a still further embodiment, the determined maximum allowable forward-sense setpoint value together with an associated code that identifies the Blu-ray disc 102 (Cf. FIG. 1) is stored for later use, either for the same disc or for the same disc brand. Further, the next time when the Blu-ray disc 102 is inserted into the drive 100 (Cf. FIG. 1), the stored maximum allowable forward-sense setpoint value is used for reading data from Blu-ray disc 102 (Cf. FIG. 1), without performing a new evaluation again.

A device 1000 (Cf. FIG. 1) for determining a maximum allowable read power for a combination of a drive 100 (Cf. FIG. 1) and a record carrier 102 (Cf. FIG. 1) has a forward-sense-setpoint-value-finding unit (1002) arranged to find a forward-sense setpoint value to control a light power control loop, by reading data from the record carrier 102 at which degradation of the data occurs. The device 1000 (Cf. FIG. 1) can be used to determine the maximum allowable read power for the combination of the Blu-ray drive 100 (Cf. FIG. 1) and Blu-ray disc 102 (Cf. FIG. 1) as illustrated in the embodiments. Alternatively, the device 1000 can be realized as a part of the Blu-ray drive 100 itself (Cf. FIG. 1).

It is also possible to carry out an estimation of the read power at one speed, and make an estimate of the allowed read power for another.

It is also noted that some media brands are more sensitive to read power than others. The drive 100 (Cf. FIG. 1) can take advantage of media 102 (Cf. FIG. 1) that are more tolerant with respect to higher read powers. These media allow higher read out speeds or simply a larger detection margin at lower read speeds utilizing the increased read power. At the same time, known problem discs can still safely be read out by the drive, but maybe at lower speed with reduced read power. It is possible to use media brand-specific read power in the drive 100. For all known media the tolerated read power for the drive is stored in the storage unit (e.g. internal drive memory). During playback (reading), this media-specific read power can be used to increase the playback (read) margins. For all unknown media the nominal read power can be used in the drive. Alternatively, the media-brand dependent read power can be stored in a media table. In essence, it is possible to discriminate read power per media brand (i.e. for each media brand) and store the pre-determined media-brand dependent read powers in a storage unit.

Although the invention has been explained by embodiments using Blu-ray drives and Blu-ray discs, the invention is applicable to all types of optical disc media and optical drives, e.g. write-once media and write-many recordable types (CD-RW, DVD-RW, DVD+RW, Blu-ray discs). A person skilled in the art can implement the described embodiments of the method in software or in both hardware and software. It is also possible to do the estimation at one speed, and make an estimate of the allowed read power for another speed. Other variations to the disclosed embodiments can be understood and effected by those skilled in the art of practicing the claimed invention, from a study of the drawings, the disclosure and the appended claims. The use of the verb “comprise” does not exclude the presence of elements other than those stated in a claim or in the description. The use of the indefinite article “a” or “an” preceding an element or step does not exclude the presence of a plurality of such elements or steps. The Figures and description are to be regarded as illustrative only and do not limit the invention.

In summary, a method of determining a maximum allowable read power for a drive-record carrier combination is described. The method finds a forward-sense setpoint value to control a light power control loop, by reading data from the record carrier at which degradation of the data occurs.

1. A method of determining a maximum allowable read power for a drive-record carrier (100,102) combination, the method comprising:
finding a forward-sense setpoint value (FS) to control a light power control loop, by reading data from the record carrier (102) at which degradation of the data occurs.

2. The method as claimed in claim 1, wherein finding the forward-sense setpoint value (FS) comprises:
finding the forward-sense setpoint value to control the light power control loop, by reading data from the record carrier (102) at which degradation of the data occurs during idle time of the drive (100).

3. The method as claimed in claim 1, wherein finding the forward-sense setpoint value comprises:
reading the data from the record carrier (102) and measuring a parameter of the read data; and
finding the forward-sense setpoint value (FS) based on the measured parameter.

4. The method as claimed in claim 3, wherein reading the data from the record carrier and measuring the parameter of the read data comprises:
a) initializing the forward-sense setpoint value to a minimum setpoint value allowable by the drive;
b) reading the data from the record carrier one-time and measuring the parameter of the read data;
c) reading the data from the record carrier N times and measuring the parameter of the read data while reading the data the N^{th} time; and
d) increasing the forward-sense setpoint value and repeating steps b and c at each forward-sense setpoint value until the forward-sense setpoint value reaches a maximum value allowable by the drive.

5. The method as claimed in claim 4, wherein finding the forward-sense setpoint value based on the measured parameter comprises:
determining the forward-sense setpoint value at which the measured parameter has changed, between one-time data readout and N^{th} time data readout, by a pre-determined amount.

6. The method as claimed in claim 5, wherein the parameter is selected from the group consisting of Jitter, symbol error rate, RF-asymmetry, RF-modulation, time interval analyzer statistics and carrier-to-noise ratio.

7. The method as claimed in claim 5, further comprising:
applying a pre-determined safety margin to the found forward-sense setpoint value.

8. The method as claimed in claim 1, further comprising:
storing in the drive (100) the found forward-sense setpoint value (FS) together with an associated code that identifies the record carrier (102).

9. The method as claimed in claim 8, wherein the method further comprises:
reading the associated code that identifies the record carrier; and
reading the data from the record carrier (102) using the stored forward-sense setpoint value (FS) related to the record carrier (102).

10. A device (1000) for determining a maximum allowable read power for a drive-record carrier (100,102) combination, the device (100) comprising:
a forward-sense-setpoint-value finding unit (1002) arranged to find a forward-sense setpoint value to control a light power control loop, by reading data from the record carrier at which degradation of the data occurs.

11. The device as claimed in claim 10, wherein the device is arranged to determine the maximum allowable read power for a combination of a Blu-ray drive and a Blu-ray disc.

12. A computer program code means to perform a method of determining a maximum allowable read power value for a drive-record carrier (100,102) combination, the method comprising:
finding a forward-sense setpoint value (FS) to control a light power control loop, by reading data from the record carrier (102) at which degradation of the data occurs.
